(19) United States
(12) Patent Application Publication
(10) Pub. No.: US 2006/0198549 A1
(43) Pub. Date: Sep. 7, 2006

(54) Method of detecting watermarks

(76) Inventors: Henricus Antonius Gerardus Van Vugt, Eindhoven (JP); Henricus Antonius Wilhelmus Van Gestel, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/551,971

(22) PCT Filed: Apr. 5, 2004
(86) PCT No.: PCT/IB04/50385

§ 371 Date: Oct. 5, 2005

(30) Foreign Application Priority Data
Apr. 11, 2003 (EP) 03100982.2

(51) Int. Cl. G06K 9/00

(52) U.S. Cl. 382/103

(57) ABSTRACT

It is difficult to detect a watermark (40) in a video image sequence (20) if the image has been subjected (possibly by a hacker) to affine transforms such as scaling, rotation, flipping, etc. The transform carried out is generally unknown. Therefore, one or more inverse transforms (60) are performed to the image prior to detection (90) until a reliable decision can be made. The inverse transforms are performed with small stepsize variations of adequate parameters. In a preferred embodiment, an initial search for correlation is done between the inverse transformed image an a blurred version of the reference watermark, the blurred reference watermark being obtained by combining a number of e.g. rotated versions of the reference watermark. If some correlation has been found, the amount of blur and/or the stepsize is decreased. This requires fewer steps to detect the watermark.

### FIELD OF THE INVENTION

The present invention relates to methods of detecting watermarks; in particular, but not exclusively, the invention relates to a method of detecting watermarks in signals and/or data corresponding to sequences of images, for example as in video signals. Moreover, the invention also relates to watermark detectors operable to detect watermarks according to the invention.

### BACKGROUND TO THE INVENTION

It is well known that watermarks are susceptible to being included in items of value, for example in bank notes, for use in confirming authenticity of such items and/or detecting counterfeits thereof. Similar considerations pertain to data of value and/or signals of value to determine one or more of authenticity thereof and routes of distribution thereof. The latter is especially important for video films and/or video data where unauthorised copying, namely potential copyright infringement often referred to as “hacking”, can have serious economic consequences for original owners and/or authorised distributors of the video films and/or data. In copyright infringement, evidence of unauthorised copying is required as a precursor to taking legal action.

Unlike banknotes and similar tangible items of value, video films and/or video data are only susceptible to including watermarks by way of intentional perturbation thereof to imprint effectively signal and/or data watermarks.

In contemporary literature pertaining to methods of applying watermarks to audio and video signals and/or data, numerous approaches have been adopted for including subtle information into such signals and/or data for applying watermarks thereto. Such subtle information is substantially imperceptible when viewing and/or listening to the signals and/or data. For video signals and/or video data, watermarks are included at a magnitude comparable with a noise threshold of such signals and/or data; during detection of the watermarks, their data and/or signals are integrated, namely accumulated, with time to obtain a more reliable watermark indication. Image noise and normal programme material accumulated with respect to time integrates ultimately to zero whereas accumulated watermark data progressively integrates to a distinct pattern with time.

For example, in European patent application EP-A-1 156 660, there is described a device and method for detecting digital watermark information inserted into original image information, such original image information originally including a digital watermark which has been deleted, altered or deformed by executing one or more deforming operations to the original information. The device includes first means for calculating from obtained image information a matrix and a transposed matrix about a system matrix, second means for calculating an estimated initial image vector from the obtained image information, third means for calculating a residual vector of the image information, fourth means for calculating a square error of the residual vector, fifth means for determining whether or not the residual vector square error is of a minimum value, sixth means for calculating a correcting vector, seventh means for calculating a reverse-rotated image, eighths means for substituting an output from the seventh means with a value calculated from the second means, nineth means for obtaining an estimated value of the original image information when the minimum value of the residual vector square error is detected, and tenth means for retrieving digital watermark information from the estimated image information of the original image information and for displaying the retrieved digital watermark information. The device is capable of detecting bona fide proprietary original image information which has been subjected to unauthorised processing aimed at removing watermarking applied to the original information, for example by unauthorised distributors and/or hackers abusing copyright in the original image information.

The inventors have appreciated that it is difficult to detect a watermark in video image information if images thereof have been subjected, for example by a hacker, to affine transforms. Affine transforms in the context of the present invention are considered to comprise one or more of image scaling, image rotation, image flip and similar spatial rearrangements, and combinations of such rearrangements. Moreover, the inventors have appreciated that transforms applied by hackers are usually not known in advance when analysing received image information; consequently, the inventors have appreciated that it is desirable to perform an exhaustive series of inverse transforms to such received information to determine whether or not a watermark is present before a decision is made regarding authenticity of the received information based upon watermark detection. However, the inventors have also appreciated that such an exhaustive search is impracticable and/or prohibitively costly to perform in practice using contemporary watermark arrangements on account of data processing capacity required to execute such an exhaustive series of transforms.

Thus, the inventors have devised not only watermarks suitable for such an exhaustive series of transforms, but also apparatus for detecting such watermarks.

The inventors are aware of earlier attempts to provide more robust watermarking detection methods. For example, in international PCT patent application WO-A-01/24113, there is disclosed that most contemporary watermarking schemes are not resistant to manipulations such as geometric distortions of a watermarked image, because such manipulations destroy correlation between an original watermark employed to label the image and a distorted version of the original watermark present in the manipulated image. The PCT application discloses a method and arrangement for restoring such a correlation. In the method, a suspect image is analysed for the presence of a repeated data pattern. If the method identifies presence of such a pattern, it is concluded therefrom that the image has been watermarked by “tiling” a small-sized watermark pattern over the extent of the image; “small-size” in the context of the method means substantially smaller than the extent of the image, for example each watermark pattern has an associated area in the image in the order of 1% of the total area of the image when spatially reconstituted. An actual detection of whether or not a watermark detected in the suspect image is a given watermark W is subsequently performed in the method by determining the periodicity of the pattern found in the suspect image, and then processing the suspect image so as to match the periodicity of the pattern therein with a calculated periodicity anticipated for the given watermark W to be detected. If the suspect image indeed is found to include the given watermark W, the geometric manipulation is thereby undone and the manipulated image thus authenticated.

### SUMMARY OF THE INVENTION

It is an object of the present invention to provide a more robust method of detecting watermarks in signals and/or data corresponding to sequences of images, for example as in video signals.

It is also an object of the invention to provide more robust watermark detectors operable to detect watermarks in signals and/or data corresponding to sequences of images, for example as in video signals. In this respect, it is a further object of the invention to provide such detectors whilst only utilizing a limited amount of memory and associated control logic, so that existing detectors can be modified to function according to the invention.

It is also an object of the invention to provide a signal and/or data encoded with more robust watermarks.

According to a first aspect of the present invention, there is provided a method of detecting watermarks in data/signals corresponding to a sequence of images, the method including the steps of:
(a) accumulating data corresponding to a spatial sub-region of one or more images in the sequence, and storing the accumulated data in a first memory;
(b) performing one or more transformations on the accumulated data to generate corresponding transformed data for storing in a second memory:
(c) comparing the transformed data stored in the second memory with one or more reference watermarks to determine associated one or more degrees of similarity; and
(d) outputting one or more results indicative of whether or not said one or more degrees of similarity exceed one or more defined similarity thresholds, and thereby indicative of whether or not one or more of the reference watermarks are present in the sequence of images.

The method is of advantage in that it is capable of providing more robust detection of watermarks in signals and/or data corresponding to sequences of images.

Preferably, the spatial sub-region of said one or more images corresponds to a substantially central sub-region thereof.

Preferably, in the method, comparison in step (c) of said transformed data in the second memory means with said one or more reference watermarks is executed by way of correlation. The use of correlation is beneficially capable of rendering the method executable using contemporary watermark detection hardware.

Preferably, the steps (a) to (d) are executed in one or more of hardware and software in a time division multiplexed manner during which said one or more of hardware and software is capable of executing other functions. Such time division multiplexing is of advantage in that the method can be executed efficiently on hardware and/or in software which also provides other functions whilst providing the method with sufficient time to execute a sufficient accumulation in step (a).

Preferably, in order to potentially avoid inaccurate correlation to said one or more reference watermarks, the second memory is of sufficient memory capacity so that all data elements present in the first memory are mapped in step (b) by said one or more transformations onto corresponding elements in the second memory, thereby substantially circumventing loss of information associated with transforming spatially peripheral regions of the accumulated data.

Preferably, in order to reduce memory requirements, the first and second memories are arranged to have a capacity corresponding substantially to data associated with the spatial sub-region of the one or more images in the sequence.

Preferably, the steps (b) and (c) are executed a plurality of times to provide a substantially exhaustive search through the accumulated data in said first memory means within defined searching limits for detecting the presence of one or more watermarks in the accumulated data. The inventors have appreciated that such exhaustive searching is not practically and/or economically feasible using contemporary watermark detection methods so that contemporary watermark detection methods are potentially capable of missing detection of watermarks.

Preferably, in order to try to circumvent mis-detection of watermarks where the method of the invention is implemented using modest amounts of memory, a Hanning-type window is applied to the transformed data stored in the second memory in step (c) before comparing with said one or more reference watermarks. More preferably, in order to improve correlation detection, the Hanning-type window is arranged to have progressively decreasing spatial peripheral extent. Most preferably, the Hanning-type window is described by a smoothly-changing function. Moreover, the Hanning-type window can be implemented according to a range of functions, for example a polynomial function such as a quadratic function having a central maximum, a trigonometric function such as a cosine having a central maximum, a linear triangular function having a central maximum or any combination thereof either implemented smoothly or in a step-wise discrete manner. The Hanning-type window is susceptible to having mutually dissimilar scaling along its spatial orthogonal directions.

Beneficially, in order to improve reliability of watermark detection and yet accommodate a potentially wider range of hacking transformations, said one or more reference watermarks are preferably blurred representations of corresponding one or more unblurred reference watermarks. More preferably, the method is arranged to employ blurred representations of said one more unblurred reference watermarks for initially identifying one or more watermarks present in the accumulated data, and then subsequently arranged to employ substantially unblurred reference watermarks for analysing the data; such a variant of the method is capable of providing both rapid and highly accurate watermark detection.

Preferably, the data accumulated in step (a) in the first memory is continuously updated as images of the sequence are received, and the steps (b) to (d) are repetitively applied to said continuously updated accumulated data

Preferably, in order to detect a wide range of hacking transformations used to circumvent watermark detection, said one or more transformations in step (b) include at least one of translation, rotation, skew, warp, scaling and flip transformations.

The inventors have appreciated that the method of the invention is beneficially backwardly compatible with existing watermark detection methods. Therefore, preferably, the method is employed temporally alternately or concurrently with one or more conventional watermark detection processes. More preferably, the method is invoked when said one or more conventional detection processes fail to detect the presence of one or more watermarks in the sequence of images.

Beneficially, the inventors have appreciated that the method according to the first aspect of the invention is executable in one or more of a settop box, a DVD player, a DVD recorder, an MPEG encoder, an MPEG decoder, a VWM marker, a data storage device and a display device.

According to a second aspect of the present invention, there is provided a watermark detector for detecting watermarks in data/signals corresponding to a sequence of images, the detector including:
(a) accumulating means for accumulating data corresponding to a spatial sub-region of one or more images in the sequence, and a first memory for storing the accumulated data generated by the accumulating means;
(b) transforming means for performing one or more transformations on the accumulated data from the first memory to generate corresponding transformed data for storing in a second memory:
(c) comparing means for comparing the transformed data stored in the second memory with one or more reference watermarks to determine associated one or more degrees of similarity; and
(d) outputting means for outputting one or more results indicative of whether or not said one or more degrees of similarity exceed one or more defined similarity thresholds, and thereby indicative of whether or not one or more of the reference watermarks are present in the sequence of images.

Preferably, the detector is incorporated into one or more of a settop box, a DVD player, a DVD recorder, an MPEG encoder, an MPEG decoder, a VWM marker, a storage device and a display device.

According to a third aspect of the present invention, there is provided data and/or signals corresponding to a sequence of images, said images having a plurality of mutually different watermarks applied to mutually different spatial sub-regions thereof. Preferably, for improving watermark detection robustness and/or detection speed, the watermark details are arranged to be susceptible to correlation with a blurred version of corresponding reference watermarks. Preferably, at least one of the spatial sub-regions corresponds to a substantially central region of the images. Preferably, the data and/or signals are recorded on a data carrier, for example a compact disc (CD), a DVD disc and/or a video magnetic tape.

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagrams wherein:

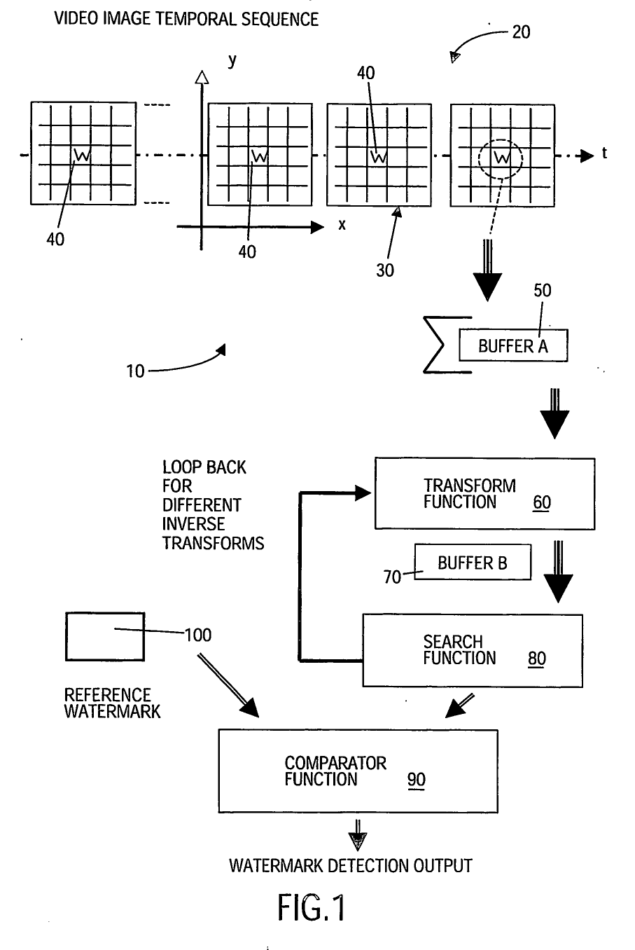

FIG. 1 is a schematic representation of principle steps of a method according to the invention;

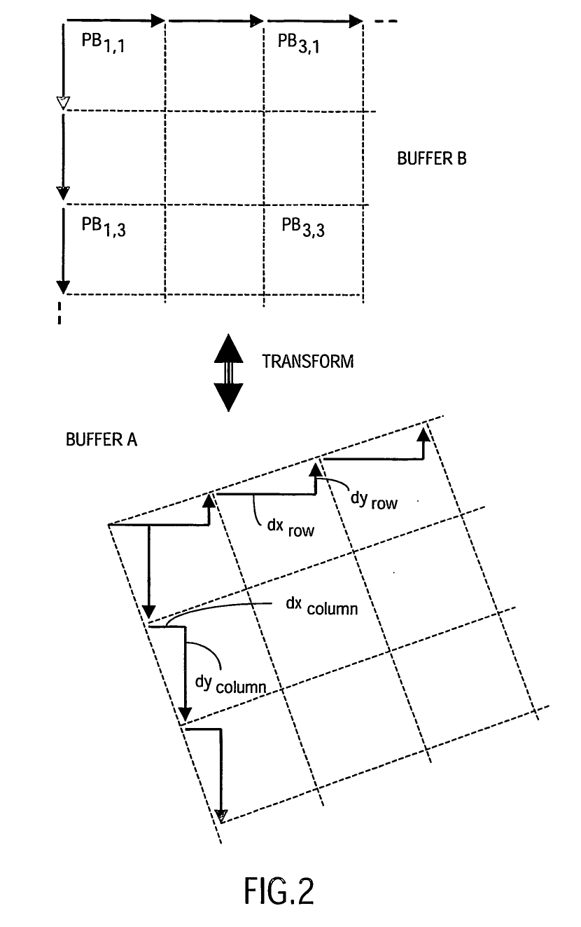

FIG. 2 is a schematic representation of an example of a transform function utilized in the method of FIG. 1;

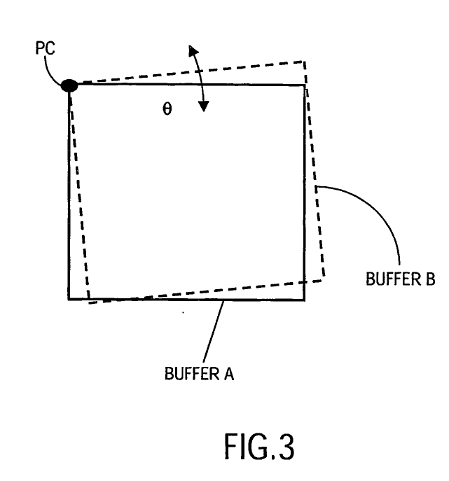

FIG. 3 is a schematic representation of a spatial mapping provided by the example transform function of FIG. 2;

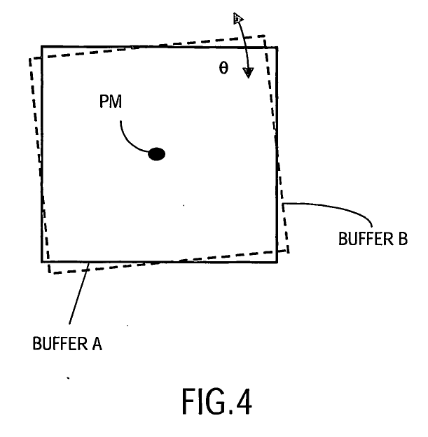

FIG. 4 is a schematic representation of an alternative spatial mapping provided by a variant of the example transform function of FIGS. 2 and 3;

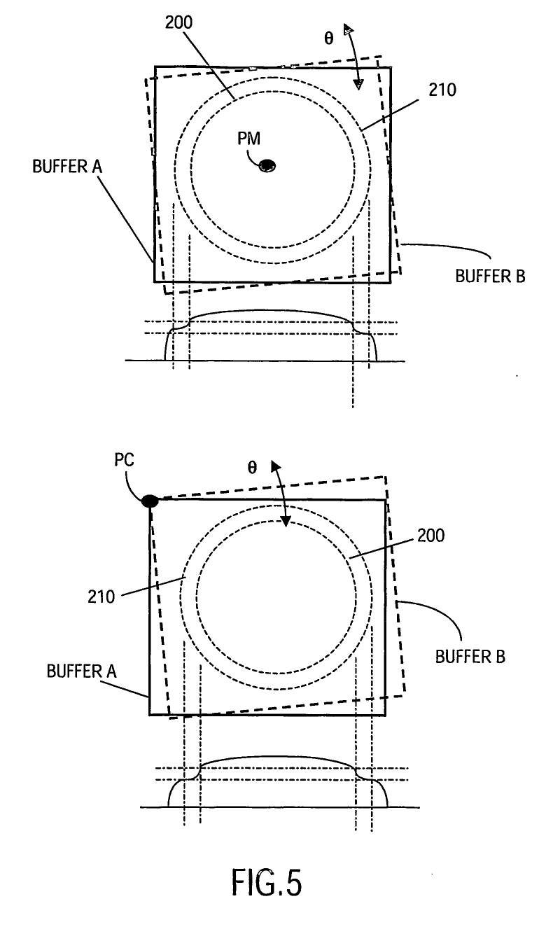

FIG. 5 is an illustration of a pre-correlation Hanning-type window applied to reduce errors arising from mapping outside spatial ranges of buffers employed in executing the method of FIG. 1;

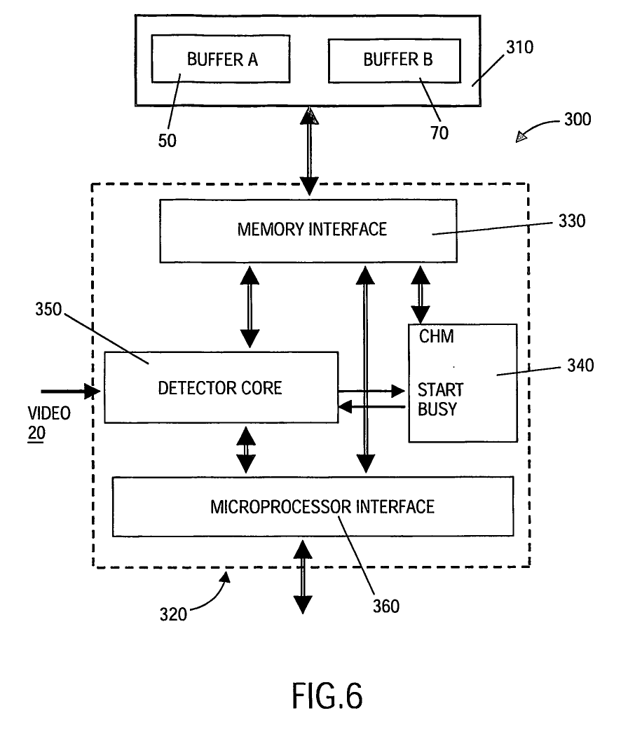

FIG. 6 is a schematic illustration of hardware required to implement the method of FIG. 1; and

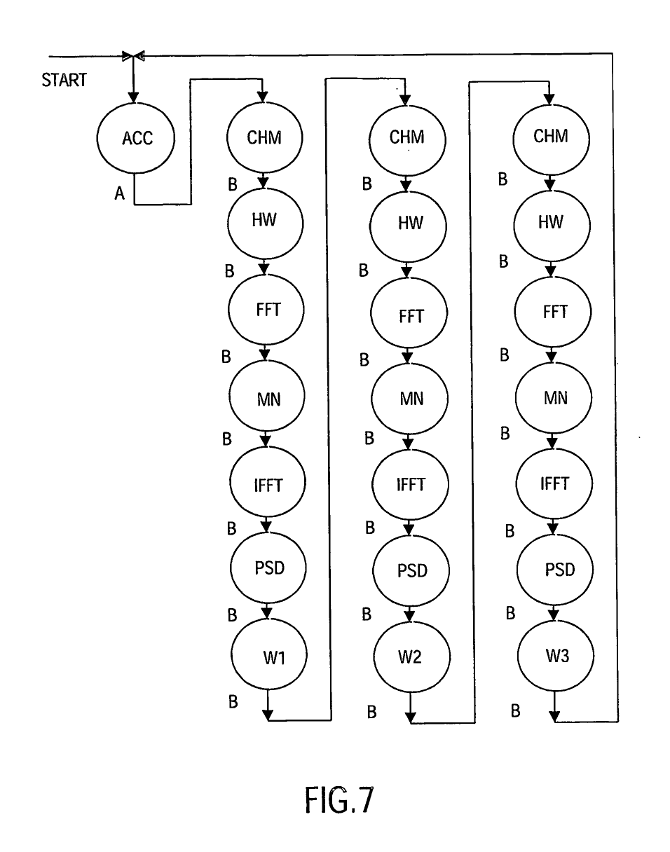

FIG. 7 is a schematic diagram, presented in the form of a state machine, illustrating operation of the hardware of FIG. 6.

### DESCRIPTION OF EMBODIMENTS OF THE INVENTION

In order to describe the invention, contemporary approaches to providing signal watermarks will be considered. For example, there is a well known contemporary watermarking system known as VWM which is frequently employed.

Contemporary VWM watermark detectors are not capable of coping with future hackers whose hacking approaches are based on small geometric transformations of watermarked video signals, such small transformations being other than just merely image scaling in one or more dimensions. For example, a small transformation corresponding to an image rotation of more than 1° is susceptible to resulting in misdetection of watermarks in conventional VWM watermarking systems, such a degree of rotation being almost imperceptible to people viewing hacked and/or pirated images, for example as in counterfeit DVD video recordings. Other small transformations such as image shear, image warp, and horizontal and/or vertical flip are also potentially capable of confusing conventional VWM watermark detectors. Moreover, it is extremely difficult to execute inverse rotation on entire images encoded according to internationally-recognized MPEG standards.

The inventors have therefore devised a straightforward and low-cost method of extending functionality of contemporary VWM watermark detectors to enable them to cope with geometrically-transformed video information which would otherwise be mishandled by such contemporary VWM detectors. The method enables contemporary VWM watermark detectors to cope with at least affine transformations such as scaling, rotation, shear, warp, and horizontal and/or vertical reflection flip. A key element of the method is to perform an exhaustive search on an accumulated small portion of a series of video images received by repetitively applying inverse transforms thereto where each transform is followed by a correlation measurement to try to identify one or more watermarks. Such an approach is distinguished from the prior art where each image is analysed in its entirety for watermarks. On account of selecting only a small portion of each image for purposes of exhaustive testing, memory and associated hardware requirements for implementing the present invention are more modest. The inventors have constructed and subsequently characterised detectors functioning according to the method of the invention; the detectors have been found to be highly reliable and capable of handling MPEG-type image information.

The method of the invention will now be described in greater detail.

In overview, the method of the invention utilizes a combination of three principles:
(a) a small region of each image in a sequence of images, for example a 128×128 pixel region in a middle region of each image, is accumulated over a period of time, for example several consecutive images, to provide an accumulated data set for watermark detection purposes;
(b) the accumulated data is subjected to an exhaustive search, within selected limits, wherein the accumulated data is subjected to at least one inverse transformation generating corresponding transformed data which is then tested for correlation with one or more reference watermarks, thereby determining which of the at least one inverse transform identifies occurrence of a watermark in the small region with greatest reliability; and
(c) incorporation of the principles of (a) and (b) above into existing watermark detectors by way of time-multiplexed integration.
   These principles (a) to (c) introduced in the foregoing will now be elucidated in greater detail with reference to FIG. 1.

In FIG. 1, there is shown a method of the invention indicated generally by 10. The method 10 involves receiving a temporal sequence of images 20, for example comprising an image 30. In a spatial sub-region of each image, for example a central region 40 of the image 30 although a sub-region remote therefrom can alternatively be employed, there is included a watermark field where a spatial representation of a watermark pattern W in superimposed on the image at a magnitude which is substantially imperceptible when individual images are viewed but which, when integrated, namely accumulated, over several of the frames is clearly distinguishable above background noise and programme material present in the images. If desired, the watermark pattern W can be tiled throughout each image 30 including the region 40 in a manner similar to conventional VWM watermarking.

The method 10 is operable to receive the sequence 20 of images 30 and to accumulate their central regions 40 to provide an accumulated matrix 50 stored in a first memory buffer A. Next, a transform function 60 is applied to the matrix 50 to generate a corresponding transformed matrix 70 for storage in a second memory buffer B. The transformed matrix 70 is subsequently passed by a search function 80 to an associated comparator function 90 which is operable to compare the transformed matrix 70 with a reference watermark 100; if a correlation match within predefined matching criteria is found between the reference watermark 100 and the transform matrix 70, the sequence 20 is deemed to include a watermark substantially similar to the reference watermark 100. If required, the search function 80 is operable, within predefined search limits, to invoke the transform function 60 repetitively for various combinations of transform parameters input thereto so that an exhaustive search of possible transforms is executed for determining whether of not the reference watermark 100 is included in images 30 of the sequence 20.

Steps of the method 10 represented in FIG. 1 will now be described in greater detail. The central region 40 of each frame is preferably implemented by a field of 128×128 pixels as employed in conventional VWM. Such a small area is desirable because a relatively modest amount of memory is required to store such a field in the form of a pixel matrix. Preferably, the amount of memory is just sufficient in size to accommodate the region 40. In view of the discrete pixel nature of the region 40, its relatively small size and central location, hacking operations such as rotation, warp and/or shear performed on the sequence of images 20 have relatively little effect on reliability of the method 10 to detect the presence of watermarks in images of the sequence 20. Although a field of 128×128 pixels is utilized for the central region 40 in the method 10 represented in FIG. 1, it will be appreciated that other sizes for the region 40 are possible; for example, the region 40 is preferably in a range of 10×10 pixels to 500×500 pixels in size, is more preferably in a range of 30×30 pixels to 300×300 pixels in size, and most preferably in a range of 50×50 pixels to 160×160 pixels in size, for example substantially 128×128 pixels in size.

From an image spatial viewpoint, the spatial sub-region of said one or more images corresponds to a pixel region thereof comprising not more than 20% of pixels present in said one or more images; such a range is found by the inventors to be an optimal compromise between robustness of watermark detection and modest memory and logic hardware requirements to implement the method. More preferably, the spatial sub-region of said one or more images corresponds to a pixel region thereof comprising not more than 5% of pixels present in said one or more images. Most preferably, the spatial sub-region of said one or more images corresponds to a pixel region thereof comprising not more than 2% of pixels present in said one or more images.

Whereas a larger region 40 is capable of providing a more precise correlation in the comparator function 90 whilst providing a very specific spatial form of watermark, a smaller region 40 is capable of providing a less specific but yet more robust watermark. The size for the region 40 is thus selectable depending upon a degree of watermark uniqueness required, and a degree of robustness desired in conjunction with memory and hardware necessary for implementing the method 10. Moreover, as elucidated in the foregoing, it will be appreciated that the region 40 need not be central but can optionally be off-centre in the image 30 in variations of the method 10.

The inventors have appreciated that it is especially desirable to select watermark information only from the central region 40, even though the image 30 is tiled in other regions thereof with watermark information. Contemporary approaches to extracting watermark details from sequences of video images employ “folding”. In folding, watermark information is accumulated from numerous sub-regions throughout an image tiled with watermark patterns. Use of such peripheral regions in folding for watermarking detection purposes renders watermark correlation to be a sensitive function of image rotation resulting in costly and complex contemporary hardware for reliably checking watermarked images. For example, in contemporary image watermarking approaches where folding and correlation are employed, it is known to the inventors that a rotational change in a range of 1° to 2° to watermarked images is sufficient to cause there to be non-detection of the presence of watermarks, namely a correlation peak height generated during checking of the presence of watermarks in such folded watermarked images is insufficient to exceed an associated pre-defined correlation threshold in contemporary watermark detectors.

In utilizing the method 10, the inventors have appreciated that a trade-off exists between time for accumulating the central regions 40 of images 30 to generate the matrix 50 and spatial extent of the watermark in the central regions 40; indeed, the inventors have appreciated that a favourable solution arises for providing robust watermark detection when the regions 40 are relatively smaller in comparison to whole-image contemporary watermarking and when longer integration times are employed.

The transform function 60 employed in the method 10 will now be described in greater detail. In operation, the matrix 50 is stored in a first 128×128 pixel memory buffer, namely the aforementioned buffer A. Moreover, the transform function 60 is arranged to perform an inverse transformation. This inverse transformation is executed by copying contents of the buffer A and mapping them onto a second buffer, namely the aforementioned buffer B.

The buffer A comprises pixel elements PA_{i,j} where subscripts i,j correspond to image pixels locations with reference to horizontal (x) and vertical (y) spatial directions respectively when the image 30 is viewed. Thus, for the central region 40 having a size of 128×128 pixels, an element PA_{64, 64} corresponds to accumulation of a central pixel in the sequence 20 of images 30. Similarly, the buffer B comprises pixel elements PB_{k, l} where subscripts k, l are each in a range of 1 to 128. The transform function 60 is operable to receive elements from the first buffer A and map them onto the second buffer B. Moreover, the function 60 can be arranged to perform a variety of mutually different inverse transforms.

In order to provide an example of the function 60, a rotation function will be considered corresponding to a buffer rotation of an angle θ as illustrated in FIG. 3. For such a rotation function, there exists a following parameter set:
dx_{row}, dy_{row}, dx_{column}, dy_{column}
which relate to associated vectors as illustrated in FIG. 2. This Figure is to be interpreted as follows. Buffer B is filled from left to right and from top to bottom. For each pixel in buffer B the address of a corresponding pixel in buffer A is determined. While going in horizontal (row) direction through buffer B, for each next pixel in buffer B the address for buffer A is updated with a step dx_{row} in horizontal direction and a step dy_{row} in vertical direction. Similarly, when going in vertical (column) direction through buffer B, for each next pixel in buffer B the address for buffer A is updated with a step dx_{column} in horizontal direction and dy_{column} in vertical direction.

The aforementioned parameter set defines sub-pixel accuracy. In the examples given below, the value 256 represents a step of 1 pixel. With the parameter set, many types of transform functions 60 can be described. Corresponding parameter sets for defining vectors in a manner akin to FIG. 2 are herewith provided in Table 1. It will be appreciated that skew and warp can similarly be accommodated by the transform function 60.

TABLE 1

| | dx_{row} | dy_{row} | dx_{column} | dy_{column} |
|---|---|---|---|---|
| Default (=normal spatial copy from | +256 | 0 | 0 | +256 |
| buffer A to buffer B) | | | | |
| Horizontal flip | −256 | 0 | 0 | +256 |
| Vertical flip | +256 | 0 | 0 | −256 |
| Rotation = +2° (counterclockwise) | +255 | −4 | +17 | +255 |
| Rotation = −2° (clockwise) | +255 | +4 | −17 | +255 |
| Scaling +2% (zoom in) | +250 | 0 | 0 | +250 |
| Scaling −2% (zoom out) | +261 | 0 | 0 | +261 |
| Rotation = +2°; | +250 | −4 | +17 | +250 |
| scaling +2% | | | | |
| Rotation = +45° | +181 | −90 | +362 | +181 |
| Scaling +50% | +170 | 0 | 0 | +170 |
| Rotation = +45°; | +120 | −60 | +241 | +120 |
| scaling +50% | | | | |

Beneficially, the inventors have found that a rotation function is straightforward to implement in hardware, although a slight scaling error potentially arises by the implementation; on account of the central region 40 being relatively small, this scaling error is of substantially insignificant relevance to successful operation of the method 10.

It will be appreciated from Table 1 that dy_{row} and dx_{column} parameters are not identical in case of rotation, for example differing in sign. Such difference arises because when video frames are rotated through a given angle, the parameters correspond to frame rotation rather than field rotation.

As shown in FIG. 3, rotation about a corner point PC at a top left-hand corner of the buffers A, B causes some elements in buffer A to be spatially mapped outside a spatial range represented in buffer B. Such mapping potentially causes a loss of data at peripheral elements of the buffers A, B which can result in degraded correlation detected by the comparator function 90 when comparing the transformed matrix 70, namely the buffer B, with the reference watermark 100.

The inventors have appreciated that there are two approaches for reducing the potential loss of data.

In a first approach, the parameters of Table 1 and the transform function 60 are arranged to provide a reference point for the transform function 60 substantially at a centre point PM of the buffer A as illustrated in FIG. 4; the centre point PM should be compared with the corner point PC of FIG. 3. As a consequence of applying rotation effectively about the centre point PM, peripheral errors introduced by the transform function 60 are correspondingly reduced. The centre point PM is preferably centralized to an extent not exceeding 20% of the spatial distance from the centre of the buffer A to its nearest peripheral edge, more preferably not exceeding 10% thereof, and most preferably not exceeding 5% thereof.

In a second approach, a Hanning-type window is applied by the search function 80 to the buffer B to provide a spatially modulated buffer for correlation with the reference watermark 100 in the comparator function 90. Preferably, the Hanning-type window is provided with a progressively decreasing boundary with a greater weighting towards a central region of the Hanning-type window. Moreover, the Hanning-type window is susceptible to being implemented so that its spatial modulation is described by a range of functions, for example a polynomial function such as a quadratic function having a central maximum, a trigonometric function such as a cosine having a central maximum, a linear triangular function having a central maximum or any combination thereof, either implemented smoothly or in a step-wise discrete manner. The Hanning-type window can be described by a function having mutually different scaling in spatially orthogonal directions. The reference watermark 100 is also preferably similarly spatially modulated when performing the correlation. Examples of such a Hanning-type window are provided in FIG. 5, one for rotation around the corner point PC, and one for rotation around the centre point PM.

In FIG. 5, there is shown a step-wise implementation of a Hanning-type window comprising a inner Hanning boundary 200 and an outer Harming boundary 210. For elements of the buffer B lying within the inner boundary 200, more weight is given during correlation in the comparator function 90 in comparison to elements in the buffer B within an annular region between the two boundaries 200, 210. For elements lying outside the outer boundary 210, further reduced weighting can be applied thereto when performing correlation within the comparator function 90. If required, elements of the buffer B lying outside the outer boundary 210 can be disregarded for correlation purposes, namely provided with zero weighting. Moreover, if desired, a single Hanning boundary can be employed for simplicity; optionally, elements of the buffer B lying outside such a single Hanning boundary can be ignored.

It will be appreciated that the first and second approaches are susceptible to be applied simultaneously as depicted in FIG. 5.

As an alternative, or addition, to one ore more of the first and second approaches, the buffers A, B can simply be made spatially much greater than required to accommodate pixel information from the central region 40, namely to encompass a region of each image 30 extending beyond the central region 40. Although such an approach requires the buffers A, B to be larger than absolutely necessary, it does reduce peripheral boundary errors from influencing accurate execution of correlation in the comparator function 90.

Use of one or more Hanning windows in the second approach has been demonstrated in practice to enable the method 10 to cope with images that have been hacked by applying an 8° image rotation to try to circumvent watermark detection.

In the foregoing, it will be appreciated that the method 10 can be arranged to apply one or more transformations, for example according to Table 1 but not limited to functions disclosed therein, by way of the transform function 60 to data in the first buffer A to generate corresponding data in the second buffer B, and the search function 80 can be arranged to supply results of such transformations to the comparator function 90, applying one or more Hanning-type windows if required, to data of the second buffer B when correlating with the reference watermark 100 to search for a mutual correlation indicative of a watermark similar to the reference watermark being present in the sequence of images 20.

The search function 80 is susceptible to being implemented so that it can be executed quickly and exhaustively. The following description provides an overview of operation of the method 10 in respect of the search function 80.

The sequence of images 20 is accumulated over a relatively long time period in comparison to contemporary watermark detection processes, namely the sequence of images 20 in the method 10 are accumulated over a period in a range of 5 seconds to 50 seconds, and more preferably accumulated over a period in a range of 10 to 30 seconds. At a higher relative rate, several mutually different inverse transforms are executed by the transform function 60. Execution of each transform in the transform function 80 results in associated data being stored on the second buffer B which is then subjected to watermark detection steps as described in the foregoing, such detection steps utilizing correlation with the reference watermark 100 and, where necessary, with application of a Hanning-type window before executing correlation. Output of such correlation is compared against a correlation reference threshold to determine whether or not watermarks corresponding to the reference watermark are present in the sequence of images 20. In practical hardware demonstrated by the inventors, execution of the transform function 60 applying a particular type of transformation followed by exhaustive search and correlation performed in the search and comparator functions 80, 90 took substantially 0.3 seconds.

For each repetitive execution of the transform function 60, parameters of the transform function 60 are varied to cope with different types of evasive transformation that a hacker may have applied to the sequence of images 20 to try to circumvent watermark detection. Thus, parameters of the transform function 60, for example as provided in Table 1, are varied within pre-defined boundaries with pre-defined step sizes. In demonstration hardware constructed by the inventors, a minimum value, a maximum value, and a step size for each of the aforementioned parameters dx_{row}, dy_{row}, dx_{column} and dy_{column} were employed with different parameter signs tested automatically in order for the method 10 to execute an exhaustive search of the sequence of images 20. It will be appreciated, if required, that such limits are susceptible to being applied to at least one of these four parameters when executing the method 10 in different versions.

The method 10 is preferably arranged so that it identifies which inverse transform applied by the transform function 60 to the contents of the buffer A to generate the contents of the buffer B provides a best correlation at the comparator function 90, assuming that a watermark is present and detectable in the sequence of images 20. Each time a greater degree of correlation is detected by the comparator function 90, a corresponding set of parameters utilized in the transform function 60 is stored in memory. When the exhaustive search has been completed, the parameter set providing best correlation is used for watermark checking the sequence 20 subsequently; such checking is then subsequently preferably implemented continuously. Optionally, the method 10 can be configured to repeat the exhaustive search periodically from time-to-time in case a hacker has hacked the sequence 20 of images 30 with a random temporal variation of mutually different hacking transformations, namely the hacking transformation utilized by a hacker in hacking the sequence of images 20 is temporally modified in the sequence 20 to try to evade watermark detection.

A watermark detection time of 2 minutes has been found by the inventors to be achievable using detector hardware which will be described later, an associated exhaustive search was concerned with relatively small transformations of up to 2° rotation and up to 2% image scale change.

Watermark detection time using the method 10 can be reduced by not testing for all sign combinations, for example as illustrated in Table 1. If the sequence of images 20 is not tested for horizontal flip, namely dx_{row} being negative, watermark search time for the method 10 can be reduced by a factor of 2. Similarly, the watermark search time can be further reduced by a factor of 2 by also not checking for vertical flip, namely dy_{column} being negative.

Moreover, in order to achieve an acceptably short watermark detection time, it is also important to select an appropriate step size for searching as described in the foregoing with respect to the set of parameters. If one or more of the step sizes is too small, for example a step size of 1 where 256 counts as in Table 1 represent a pixel size, watermark searching will take an unnecessarily long time to execute. Conversely, if one or more of the step sizes is too large, for example a step size of 16 where 256 counts as in Table 1 represent a pixel size, a correlation peak is potentially not found at the comparator function 90 when executing correlation and thereby the presence of a watermark in the sequence of images 20 is not reliably detected. Preferably, an optimal step size to employ lies within this range of 1 to 16 counts where 256 counts correspond to a pixel size. More preferably, the step size adopted should preferably lie within a range of 2 to 8 counts. Most preferably, the step size should be substantially 4 counts.

Although four parameters are described in the foregoing, for example in Table 1, it will be appreciated that more than four parameters can be employed to describe inverse transformations applied by the transform function 60, for example to cope with combinations of rotation, shear and warp.

When implementing the method 10 in hardware, the hardware can be arranged to selectively switch between the method 10 and more contemporary watermark detection procedures as required, the hardware thereby being backwardly compatible with existing watermarks and associated detection procedures. In this respect, if no watermark is detected using contemporary water detection processes, the hardware can be arrange to switch automatically to the method 10 to provide an extra degree of watermark detection capability to the hardware.

If the method 10 is found in certain applications to require excessive time to execute, it is susceptible to being spread in execution over a several time slots so that, for example, other time-critical functions can be executed in periods between the time slots. Such spread of execution can be arranged by design and/or dynamically depending on other execution demands placed upon hardware executing the method 10.

In order to further elucidate the method 10, hardware required for its execution will now be described with reference to FIG. 6.

In FIG. 6, there is shown a watermark detector indicated generally by 300. The detector 300 comprises a memory 310 for storing data associated with the two buffers A, B. Moreover, the detector 300 additionally comprises signal processing hardware indicated by 320, the hardware 320 including a memory interface 330 for sending data to the buffers A, B and receiving stored data therefrom. Furthermore, the hardware 320 comprises a microprocessor interface 360 for interfacing with other apparatus (not shown) coupled to the hardware, for example the apparatus can include one or more a DVD recorder, a video recorder and a video viewing screen such as a wide-format plasma screen. The hardware 320 also comprises a detector core 350 for executing watermark detection functions, for example data accumulation into the buffer A, the transform function 60 to generate data for the buffer B, the search function 80 and the comparator function 90. The hardware 320 also includes a counter-hack-module (CHM) for co-ordinating operation of the memory interface 330 and the detector core 350 for executing the method 10 in practice. The hardware 320 and its memory 310 are interconnected as shown in FIG. 6.

In FIG. 7, there is shown a flow diagram in the form of a state machine illustrating steps performed by the detector 300 of FIG. 6 in order to apply the method 10 to the detection of three reference watermarks W₁, W₂, W₃. In FIG. 7, it is to be appreciated that the method 10 does not employ a combination of folding and accumulation but merely accumulation. Moreover, rescaling is not applied as utilized in contemporary watermark detectors. Furthermore, a contemporary copy operation used in conventional watermark detection is replaced by the CHM 340 in FIG. 7. Additionally, the aforementioned Hanning window and any later associated fast Fourier transformation are executed after the CHM has operated on the sequence of images 20 referred to as “video” in FIG. 6.

In FIG. 7, the following abbreviations are employed as provided in Table 2.

TABLE 2

| A: result in buffer A | B: result in buffer B |
|---|---|
| ACC: accumulation | FFT: fast Fourier transform |
| CHM: counter hack module | IFFT: inverse fast |
| | Fourier transform |
| HW: Hanning window | MN: multiply and normalize |
| PSD: peak search and | Wn: evaluate watermark n |
| derive key | |

watermark detection for baseband

The method 10 is susceptible for use in video, but is also susceptible to being applied to MPEG-data as in MPEG-based detectors. When MPEG implementation is considered, the method 10 is arranged to unfold/accumulate discrete cosine transform (DCT) coefficients of MPEG image data after which an inverse discrete cosine transform (IDCT) is performed on coefficients to recreate image information which is then subjected to the method 10 as illustrated in FIG. 1 and executed as described in the foregoing.

It will be appreciated that the method 10 described in the foregoing and its associated detector 300 are susceptible to modification without departing from the scope of the invention as defined by the appended claims.

For example, the watermark provided to the comparator function 90 for correlation with output data from the search function 80 is preferably arranged to be a blurred version of the reference watermark 100 so that correlations performed within the comparator function 90 are less precise and give rise to less of a correlation peak as parameters driving the transform function 60 and its associated search function 80 are varied during searching for watermarks in the sequence of images 20. Use of a blurred version of the reference watermark 100 for input to the comparator function 90 means that greater step sizes can be employed when performing a search using the method 10, thereby potentially increasing execution speed of the method 10. Alternatively, or additionally, the watermark employed in the images 30 can also be a blurred representation of a watermark to render correlation more robust.

If required, the amount of blurredness of the reference watermark 100 provided to the comparator function 90 can be made dynamically variable such that a blurred version of the watermark 100 is initially used in combination with relatively coarser step sizes used in the transform function 60 and its associated search function 80. Subsequently, a less blurred version of the watermark 100 can be used in conjunction with finer step sizes for obtaining a best correlating function employed for confirming the nature of a hacking transformation used to generate the sequence of images 20 and also for increasing certainty regarding the nature of the watermark applied to the sequence 20.

The blurred version of the reference watermark 100 can be generated in several ways. For example, the blurred watermark is preferably a superposition of several rotated versions of the unblurred reference watermark 100. However, the blurred version of the reference watermark 100 can be created by using, alternatively or additionally, other transformation operations including one or more of translation, shear, warp, scaling and flip.

If required, for example to render watermark detection in the comparator function 90 more robust when initially searching for likely presence of a watermark in the sequence 20 of images 30, at least one of the accumulated matrix 50 and the transformed matrix 70 can be subjected to spatial blurring to render correlation with the reference watermark 100 less sensitive to selection of the transform function 60 when initially exhaustively searching the sequence (20).

If required, the images 30 can be adapted to include several mutually different watermarks disposed at mutually different sub-regions of the images 30. For example, a first of the watermarked regions can be located at a central region of each image 30 and publicly known (namely overt), whereas a second of the watermarked regions can be located towards and/or at a peripheral region of the images 30 and maintained secret (namely covert). Moreover, the method 10 can be configured to alternately switch between accumulating watermark information from the first and second regions and alternately correlating with corresponding overt and covert reference watermarks respectively. Such an arrangement of watermarks and detection therefore is potentially highly valuable to prevent and/or detect copyright infringement, for example as a precursor to taking legal action.

The method 10 and apparatus for executing it are susceptible to being used in a wide variety of product applications including, but not limited thereto, copy protection of video material, settop boxes, DVD players, DVD recorders, MPEG encoders, MPEG decoders, VWM markers, storage devices, display devices, and remarkers and watermark detectors. It is capable of being used for detecting hacked video image information, for example counterfeit DVD video recordings.

It will be appreciated that the method 10 is susceptible to being implemented in one or more of hardware and software. For example, it can be implemented solely in an application specific integrated circuit (ASIC). Alternatively, it can be implemented in software executable on a proprietary computing platform, for example a high-speed microcontroller or a programmable signal processing integrated circuit. As a further alternative, the method can be implemented on a proprietary computing platform to which is added some custom digital logic, namely in a mixture of both hardware and software.

In a modified version of the method 10, the reference watermark 100 is effectively a Hanning-type window. For example, watermark information is susceptible to being accumulated from first and second sub-regions of the images 30 and the reference watermark 100 then spatially applied as a Hanning-type window to accumulated data from the first sub-region to generate a corresponding Hanned data set which is subsequently spatially correlated with accumulated data from the second sub-region; where spatial correlation is identified, the images 30 are deemed to include watermark information corresponding, although not necessarily similar to, the reference watermark implemented as a Hanning-type window. Such an arrangement is capable of providing an enhanced degree of protection against hackers expected more conventional types of waterrmarks.

The sequence 20 of images 30 are susceptible to including at least one watermark applied to a sub-region thereof, the at least one applied watermark being a blurred representation of a reference watermark, the applied watermark being suitable for detection by correlation with at least one of an unblurred version and a blurred version of the reference watermark.

In the foregoing, where expressions “comprise” and “included” have been used, such expressions are to be interpreted to be non-exclusive so that other items and/or components may also be present.

The invention can be summarized as follows. It is difficult to detect a watermark (40) in a video image sequence (20) if the image has been subjected (possibly by a hacker) to affine transforms such as scaling, rotation, flipping, etc. The transform carried out is generally unknown. Therefore, one or more inverse transforms (60) are performed to the image prior to detection (90) until a reliable decision can be made. The inverse transforms are performed with small stepsize variations of adequate parameters. In a preferred embodiment, an initial search for correlation is done between the inverse transformed image an a blurred version of the reference watermark, the blurred reference watermark being obtained by combining a number of e.g. rotated versions of the reference watermark. If some correlation has been found, the amount of blur and/or the stepsize is decreased. This requires fewer steps to detect the watermark.

1. A method (10) of detecting watermarks in data/signals corresponding to a sequence of images (20), the method (10) including the steps of:
(a) accumulating data (50) corresponding to a spatial sub-region (40) of one or more images (30) in the sequence (20), and storing the accumulated data in a first memory (50; 310);
(b) performing one or more transformations (60) on the accumulated data (50) to generate corresponding transformed data (70) for storing in a second memory (70; 310):
(c) comparing (80, 90) the transformed data (70) stored in the second memory with one or more reference watermarks (100) to determine associated one or more degrees of similarity; and
(d) outputting one or more results indicative of whether or not said one or more degrees of similarity exceed one or more defined similarity thresholds, and thereby indicative of whether or not one or more of the reference watermarks are present in the sequence (20) of images (30).

2. A method according to claim 1, wherein the spatial sub-region (40) of said one or more images (30) corresponds to a substantially central sub-region (40) thereof.

3. A method according to claim 1, wherein comparison in step (c) of said transformed data (70) in the second memory means with said one or more reference watermarks (100) is executed by way of correlation (90).

4. A method according to claim 1, wherein said one or more reference watermarks (100) are Hanning-type windows for use in mutually correlating accumulated data from a plurality of watermarked sub-regions present in the sequence (20) of images (30) for watermark detection purposes.

5. A method according to claim 1, wherein the steps (a) to (d) are executed in one or more of hardware (300) and software in a time division multiplexed manner during which said one or more of hardware (300) and software is capable of executing other functions.

6. A method according to claim 1, wherein the second memory (70; 310) is of sufficient memory capacity so that all data elements present in the first memory (50) are mapped in step (b) by said one or more transformations onto corresponding elements in the second memory (70), thereby substantially circumventing loss of information associated with transforming spatially peripheral regions of the accumulated data.

7. A method according to claim 1, wherein the first and second memories (50, 70) are arranged to have a capacity corresponding substantially to data associated with the spatial sub-region (40) of the one or more images (30) in the sequence (20)

8. A method according to claim 1, wherein the steps (b) and (c) are executed a plurality of times to provide a substantially exhaustive search through the accumulated data in said first memory means within defined searching limits for detecting the presence of one or more watermarks in the accumulated data (50).

9. A method according to claim 1, wherein a Hanning-type window (200, 210) is applied to the transformed data (70) stored in the second memory (70; 310) in step (c) before comparing with said one or more reference watermarks (100).

10. A method according to claim 1, wherein the one or more reference watermarks (100) are subjected to a Hanning-type window (200, 210) in step (c) for use in comparing with the transformed data (70).

11. A method according to claim 9, wherein the Hanning-type window (200, 210) is arranged to have progressively decreasing spatial peripheral extent.

12. A method according to claim 1, wherein said one or more reference watermarks (100) are blurred representations of corresponding one or more unblurred reference watermarks.

13. A method according to claim 1, wherein in step (c) at least one of the accumulated data (50) and the transformed data (70) is subjected to blurring to render comparison with said one or more reference watermarks less sensitive to selection of the inverse transform (60).

14. A method according to claim 12, wherein the method (10) is arranged to employ blurred representations of said one or more unblurred reference watermarks for initially identifying one or more watermarks present in the accumulated data (50), and then subsequently arranged to employ substantially unblurred reference watermarks for analysing the accumulated data (50).

15. A method according to claim 1, wherein the spatial region (40) includes a blurred watermark.

16. A method according to claim 1, wherein the data (50) accumulated in step (a) in the first memory (50; 310) is continuously updated as images (30) of the sequence (20) are received, and the steps (b) to (d) are repetitively applied to said continuously updated accumulated data (50).

17. A method according to claim 1, wherein said one or more transformations (60) in step (b) include at least one of translation, rotation, skew, warp, scaling and flip transformations.

18. A method according to claim 1, wherein the method (10) in employed temporally alternately and/or concurrently with one or more conventional watermark detection processes.

19. A method according to claim 18, wherein the method is invoked when said one or more conventional detection processes fail to detect the presence of one or more watermarks in the sequence of images (20).

20. A method according to claim 1 wherein, in step (a), position of the sub-region (40) from which the data is accumulated from said images (30) is selectable between a plurality of locations within said images (30), and said one or more reference watermarks (100) for use in step (c) are chosen depending upon which of said locations is selected.

21. A method according to claim 1 arranged to be executable in one or more of a settop box, a DVD player, a DVD recorder, an MPEG encoder, an MPEG decoder a VWM marker, and storage device and a display device.

22. A watermark detector (300) for detecting watermarks in data/signals corresponding to a sequence (20) of images (30), the detector (300) including:
(a) accumulating means (50, 310, 350) for accumulating data corresponding to a spatial sub-region (40) of one or more images (30) in the sequence (20), and a first memory (50, 310) for storing the accumulated data (50) generated by the accumulating means (50, 310, 350);
(b) transforming means (330, 340, 350) for performing one or more transformations on the accumulated data (50) from the first memory (50, 310) to generate corresponding transformed data (70) for storing in a second memory (70, 310):
(c) comparing means (340, 350) for comparing the transformed data (70) stored in the second memory (70, 310) with one or more reference watermarks (100) to determine associated one or more degrees of similarity; and
(d) outputting means (360) for outputting one or more results indicative of whether or not said one or more degrees of similarity exceed one or more defined similarity thresholds, and thereby indicative of whether or not one or more of the reference watermarks (100) are present in the sequence (20) of images (30).

23. A detector (300) according to claim 22, incorporated into one or more of a settop box, a DVD player, a DVD recorder, an MPEG encoder, an MPEG decoder a VWM marker, a data storage device and a display device.
